(19) United States
(12) Patent Application Publication
(10) Pub. No.: US 2026/0205536 A1
(43) Pub. Date: Jul. 16, 2026

(54) MUTE MODE OPERATION OF AN AUDIO DEVICE

(71) Applicant: QUALCOMM Incorporated, San Diego, CA (US)

(72) Inventors: Runyuan LIU, Shanghai (CN); Jie ZENG, Shanghai (CN); Xie YINGCHAO, Shanghai (CN); Joel LINSKY, San Diego, CA (US)

(21) Appl. No.: 19/137,527

(22) PCT Filed: Feb. 23, 2023
(86) PCT No.: PCT/CN2023/077776

§ 371 Date: Jun. 10, 2025

(51) Int. Cl. H04M 1/72412

(52) U.S. Cl. CPC H04M 1/72412

(57) ABSTRACT

Various aspects of the present disclosure generally relate to wireless communication. In some aspects, an audio device may receive, from a wireless communication device (WCD), an indication that the WCD is in a mute mode. The audio device may transmit, to the WCD, one or more empty packets based at least in part on the WCD being in the mute mode. Numerous other aspects are described.

### FIELD OF THE DISCLOSURE

Aspects of the present disclosure generally relate to wireless communication and to techniques and apparatuses associated with a mute mode operation of an audio device.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the station, and the uplink (or reverse link) may refer to the communication link from the station to the AP.

The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (WPAN), which may include a Bluetooth connection, may provide for short range wireless connections between two or more paired wireless devices. For example, wireless devices such as cellular phones may utilize WPAN communications to exchange information such as audio signals with wireless headsets.

### SUMMARY

Some aspects described herein relate to a method of wireless communication performed by an audio device. The method may include receiving, from a wireless communication device (WCD), an indication that the WCD is in a mute mode. The method may include transmitting, to the WCD, one or more empty packets based at least in part on the WCD being in the mute mode.

Some aspects described herein relate to a method of wireless communication performed by a WCD. The method may include transmitting, to an audio device, an indication that the WCD is in a mute mode. The method may include receiving, from the audio device, one or more empty packets based at least in part on being in the mute mode.

Some aspects described herein relate to a audio device for wireless communication. The audio device may include a memory and one or more processors coupled to the memory. The one or more processors may be configured to receive, from a WCD, an indication that the WCD is in a mute mode. The one or more processors may be configured to transmit, to the WCD, one or more empty packets based at least in part on the WCD being in the mute mode.

Some aspects described herein relate to a WCD for wireless communication. The wireless communication device may include a memory and one or more processors coupled to the memory. The one or more processors may be configured to transmit, to an audio device, an indication that the WCD is in a mute mode. The one or more processors may be configured to receive, from the audio device, one or more empty packets based at least in part on being in the mute mode.

Some aspects described herein relate to a non-transitory computer-readable medium that stores a set of instructions for wireless communication by an audio device. The set of instructions, when executed by one or more processors of the audio device, may cause the audio device to receive, from a WCD, an indication that the WCD is in a mute mode. The set of instructions, when executed by one or more processors of the audio device, may cause the audio device to transmit, to the WCD, one or more empty packets based at least in part on the WCD being in the mute mode.

Some aspects described herein relate to a non-transitory computer-readable medium that stores a set of instructions for wireless communication by a WCD. The set of instructions, when executed by one or more processors of the WCD, may cause the WCD to transmit, to an audio device, an indication that the WCD is in a mute mode. The set of instructions, when executed by one or more processors of the WCD, may cause the WCD to receive, from the audio device, one or more empty packets based at least in part on being in the mute mode.

Some aspects described herein relate to an apparatus for wireless communication. The apparatus may include means for receiving, from a WCD, an indication that the WCD is in a mute mode. The apparatus may include means for transmitting, to the WCD, one or more empty packets based at least in part on the WCD being in the mute mode.

Some aspects described herein relate to an apparatus for wireless communication. The apparatus may include means for transmitting, to an audio device, an indication that the apparatus is in a mute mode. The apparatus may include means for receiving, from the audio device, one or more empty packets based at least in part on being in the mute mode.

Aspects generally include a method, apparatus, system, computer program product, non-transitory computer-readable medium, user equipment, base station, network entity, network node, WCD, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates a wireless communications system configured in accordance with the present disclosure.

FIG. 2 is a diagram illustrating an example of a wireless communication device, in accordance with the present disclosure.

FIG. 3 is a diagram illustrating an example of a protocol stack, in accordance with the present disclosure.

FIG. 4 depicts an example transmission of data packets from a wireless communication device to a peripheral device over a communication link, according to various aspects of the present disclosure.

FIG. 5 shows a block diagram of another example wireless communication device, according to various aspects of the present disclosure.

FIG. 6 illustrates examples of a wireless communications link, in accordance with one or more aspects of the present disclosure.

FIG. 7 is a diagram of an example associated with a mute mode operation of an audio device, in accordance with the present disclosure.

FIG. 8 illustrates examples of a wireless communications link, in accordance with one or more aspects of the present disclosure.

FIG. 9 illustrates examples of a wireless communications link, in accordance with one or more aspects of the present disclosure.

FIG. 10 is a diagram illustrating an example process performed, for example, by an audio device, in accordance with the present disclosure.

FIG. 11 is a diagram illustrating an example process performed, for example, by a wireless communication device, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

In some networks, a wireless communication device (WCD) may support applications associated with providing low-latency or lossless audio to one or more other devices, such as one or more personal audio devices. For example, a WCD may support applications and use cases associated with ultra-low-latency (ULL), such as ULL gaming, or streaming lossless audio to one or more personal audio devices (e.g., peripheral devices) of a user. In scenarios in which a user uses two peripheral devices, the WCD may support an extended personal area network (XPAN) via which the WCD may communicate with the two peripheral devices. To meet latency or lossless criteria associated with an application or use case, XPAN devices may employ a target wake time (TWT) technique for communication between the WCD and the peripheral devices. In some systems, the peripheral devices and the WCD may exchange one or more Bluetooth messages and implement a complete TWT teardown between the WCD and each of the peripheral devices. Such an exchange of Bluetooth messages and TWT teardown may introduce too much latency for some applications, such as ULL gaming or streaming lossless audio applications.

In some implementations, an audio device may receive, from a WCD, an indication that the WCD is in a mute mode. The audio device may transmit, to the WCD, one or more empty packets based at least in part on the WCD being in the mute mode.

Aspects of the disclosure are initially described in the context of a WCD. Aspects of the disclosure are additionally illustrated by and described with reference to a process flow, audio data packets (e.g., audio data packet formats), a communication timeline, encoding formats, and example XPAN topologies. Aspects of the disclosure are further illustrated by and described with reference to apparatus diagrams, system diagrams, and flowcharts that relate to low-latency parameter updates for XPANs.

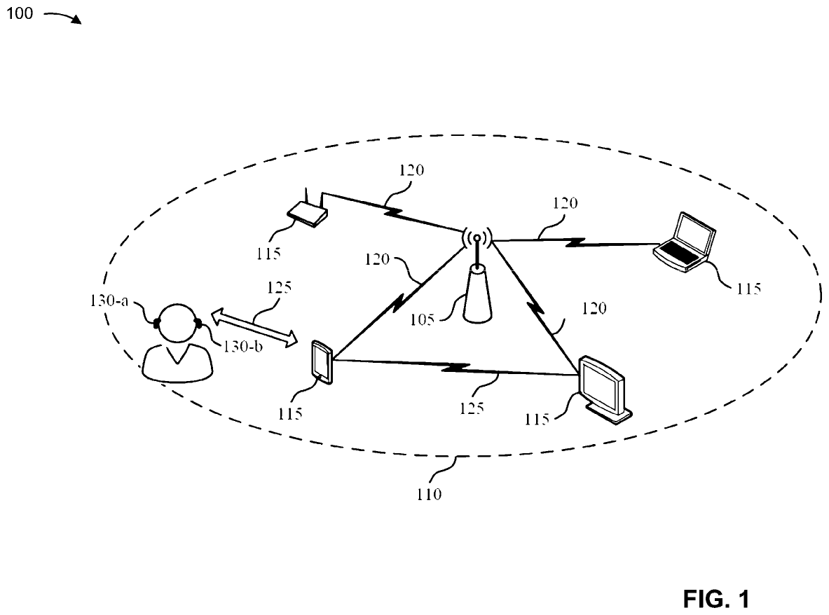

FIG. 1 illustrates a wireless communications system 100 (also known as a wireless local area network (WLAN) or a Wi-Fi network) configured in accordance with the present disclosure. The wireless communications system 100 may include an AP 105 and multiple associated devices 115 (such as stations (STAs) or SAPs, which may represent devices such as mobile stations, personal digital assistant (PDAs), other handheld devices, netbooks, notebook computers, tablet computers, laptops, display devices (e.g., TVs, computer monitors, etc.), printers, etc.). The AP 105 and the associated devices 115 (e.g., associated STAs) may represent a basic service set (BSS) or an extended service set (ESS). The various devices 115 in the network are able to communicate with one another through the AP 105. Also shown is a coverage area 110 of the AP 105, which may represent a basic service area (BSA) of the wireless communications system 100. An extended network station (not shown) associated with the wireless communications system 100 may be connected to a wired or wireless distribution system that may allow multiple APs 105 to be connected in an ESS.

Although not shown in FIG. 1, a device 115 may be located in the intersection of more than one coverage area 110 and may associate with more than one AP 105. A single AP 105 and an associated set of devices 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The wireless communications system 100 may include APs 105 of different types (e.g., metropolitan area, home network, etc.) with varying and overlapping coverage areas 110. Two devices 115 may also communicate directly via a direct wireless communication link 125 regardless of whether both devices 115 are in the same coverage area 110. Examples of direct wireless communication links 120 may include Wi-Fi Direct connections, Wi-Fi Tunneled Direct Link Setup (TDLS) links, and other group connections. Devices 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within wireless communications system 100.

In some cases, a device 115 (or an AP 105) may be detectable by a central AP 105, but not by other devices 115 in the coverage area 110 of the central AP 105. For example, one device 115 may be at one end of the coverage area 110 of the central AP 105 while another device 115 may be at the other end. Thus, both devices 115 may communicate with the AP 105 but may not receive the transmissions of the other. This may result in colliding transmissions for the two devices 115 in a contention-based environment (e.g., carrier sense multiple access with collision avoidance (CSMA/CA)) because the devices 115 may not refrain from transmitting on top of each other. A device 115 whose transmissions are not identifiable, but that is within the same coverage area 110, may be known as a hidden node. CSMA/CA may be supplemented by the exchange of a request to send (RTS) packet transmitted by a sending device 115 (or AP 105) and a clear to send (CTS) packet transmitted by the receiving device 115 (or AP 105). This may alert other devices within range of the sender and receiver not to transmit for the duration of the primary transmission. Thus, RTS and/or CTS may help mitigate a hidden node problem.

The wireless communications system 100 may include an AP 105, devices 115 (e.g., which may be referred to as source devices, central devices, etc.), and paired devices 115 (e.g., which may be referred to as sink devices, peripheral devices, etc.) implementing WLAN communications (e.g., Wi-Fi communications) and/or Bluetooth communications. For example, devices 115 may include cell phones, user equipments (UEs), wireless stations (STAs), mobile stations, PDAs, other handheld devices, netbooks, notebook computers, tablet computers, laptops, or some other suitable terminology. Paired devices 115 may include Bluetooth-enabled devices capable of pairing with other Bluetooth-enabled devices (e.g., such as devices 115), which may include wireless audio devices (e.g., headsets, earbuds, speakers, earpieces, headphones), display devices (e.g., TVs, computer monitors), microphones, meters, valves, etc.

“Bluetooth communications” may refer to a short-range communication protocol and may be used to connect and exchange information between devices 115 and paired devices 115 (e.g., between mobile phones, computers, digital cameras, wireless headsets, speakers, keyboards, mice or other input peripherals, and similar devices). Bluetooth systems (e.g., aspects of wireless communications system 100) may be organized using a central-peripheral relationship employing a time-division duplex protocol having, for example, defined time slots of 625 microseconds, in which transmission alternates between the central device (e.g., a device 115) and one or more peripheral devices (e.g., paired devices 115). In some examples, “device” 115 may generally refer to a central device, and “paired device” 115 may refer to a peripheral device in the wireless communications system 100. Consequently, in some examples, a device may be referred to as either a device 115 or a paired device 115 based on the Bluetooth role configuration of the device. That is, designation of a device as either a device 115 or a paired device 115 may not necessarily indicate a distinction in device capability, but rather may refer to or indicate roles held by the device in the wireless communications system 100. In some cases, “device” 115 may refer to a WCD capable of wirelessly exchanging data signals with another device (e.g., a paired device 115), and “paired device” 115 may refer to a device operating in a peripheral role, or to a short-range WCD capable of exchanging data signals with the device 115 (e.g., using Bluetooth communication protocols).

A communication link 125 may be established between two Bluetooth-enabled devices (e.g., between a device 115 and a paired device 115) and may provide for communications or services (e.g., according to some Bluetooth profile). The controller stack may be responsible for setting up communication links 125, such as asynchronous connection-oriented links (or asynchronous connection-oriented connections), synchronous connection-orientated (SCO) links (or SCO connections), extended synchronous connection-oriented (eSCO) links (or eSCO connections), other logical transport channel links, etc. For example, a Bluetooth connection may be an eSCO connection for a voice call (e.g., which may allow for retransmission), an asynchronous connection-less (ACL) connection for music streaming (e.g., advanced audio distribution profile (A2DP)), etc. eSCO packets may be transmitted in predetermined time slots (e.g., 6 Bluetooth slots each for eSCO). The regular interval between the eSCO packets may be specified when the Bluetooth link is established. The eSCO packets to/from a specific device (e.g., paired device 115) are acknowledged, and may be retransmitted if not acknowledged during a retransmission window. In addition, audio may be streamed between a device 115 and a paired device 115 using an ACL connection (A2DP profile). In some cases, the ACL connection may occupy 1, 3, or 5 Bluetooth slots for data or voice. Other Bluetooth profiles supported by Bluetooth-enabled devices may include Bluetooth Low Energy (BLE) (e.g., providing considerably reduced power consumption and cost while maintaining a similar communication range), human interface device profile (HID) (e.g., providing low latency links with low power requirements), etc.

A device may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some examples, Bluetooth and WLAN communications may share a same medium, such as the same unlicensed frequency medium. In such examples, a device 115 may support WLAN communications via AP 105 (e.g., over communication links 120). The AP 105 and the associated devices 115 may represent a BSS or an ESS. The various devices 115 in the network may be able to communicate with one another through the AP 105. In some cases, the AP 105 may be associated with a coverage area, which may represent a BSA.

Devices 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within wireless communications system 100, and devices may communicate with each other via communication links 120 (e.g., Wi-Fi Direct connections, Wi-Fi TDLS links, peer-to-peer communication links, other peer or group connections). AP 105 may be coupled to a network, such as the Internet, and may enable a device 115 to communicate via the network (or communicate with other devices 115 coupled to the AP 105). A device 115 may communicate with a network device bi-directionally. For example, in a WLAN, a device 115 may communicate with an associated AP 105 via downlink (e.g., the communication link from the AP 105 to the device 115) and uplink (e.g., the communication link from the device 115 to the AP 105).

In some examples, content, media, audio, etc. exchanged between a device 115 and a paired device 115 may originate from a WLAN. For example, in some examples, device 115 may receive audio from an AP 105 (e.g., via WLAN communications), and the device 115 may then relay or pass the audio to the paired device 115 (e.g., via Bluetooth communications). In some examples, certain types of Bluetooth communications (e.g., such as high quality or high definition (HD) Bluetooth) may require enhanced quality of service. For example, in some examples, delay-sensitive Bluetooth traffic may have higher priority than WLAN traffic.

In some deployments, a WCD may support applications associated with low-latency or lossless audio to one or more other devices, such as one or more personal audio devices. For example, a WCD may support applications and use cases associated with ULL, such as ULL gaming, or streaming lossless audio to one or more personal audio devices (e.g., peripheral devices) of a user. In scenarios in which a user uses two peripheral devices (e.g., a wireless earbud 130-a and a wireless earbud 130-b), the WCD may support an XPAN via which the WCD may communicate with the two peripheral devices.

As indicated above, FIG. 1 is provided as an example. Other examples may differ from what is described with respect to FIG. 1.

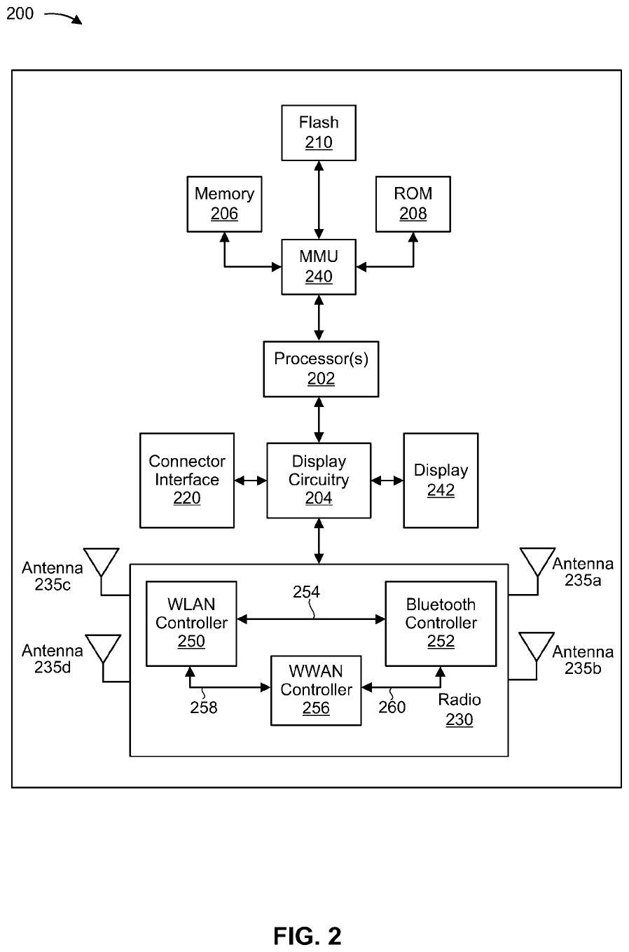

FIG. 2 is a diagram illustrating an example of a wireless communication device 200, in accordance with the present disclosure. In some instances, the wireless communication device 200 may be an example of the device 115 of FIG. 1. In other instances, the wireless communication device 200 may be an example of one or more of the devices 115 or the earbuds 130-a or 130b (e.g., an audio device) of FIG. 1. In some aspects, the wireless communication device 200 may be a Bluetooth-enabled device (such as a BLE device).

As shown, the wireless communication device 200 may include a processing element, such as processor(s) 202, which may execute program instructions for the wireless communication device 200. The wireless communication device 200 may also include a display 242 that can perform graphics processing and present information to a user. The processor(s) 202 may also be coupled to memory management unit (MMU) 240, which may be configured to receive addresses from the processor(s) 202 and translate the addresses to address locations in memory such as memory 206, ROM 208, or Flash memory 210) and/or to address locations in other circuits or devices, such as the display circuitry 204, radio 230, connector interface 220, and/or display 242. The MMU 240 may also be configured to perform memory protection and page table translation or set up. In some aspects, the MMU 240 may be included as a portion of the processor(s) 202.

The processor(s) 202 may be coupled to other circuits of the wireless communication device 200. For example, the wireless communication device 200 may include various types of memory, a connector interface 220 through which the wireless communication device 200 can communicate with the computer system, and wireless communication subsystems that can transmit data to, and receive data from, other devices based on one or more wireless communication standards or protocols. For example, in some aspects, the wireless communication subsystems may include (but are not limited to) a wireless local-area network (WLAN) subsystem, a Bluetooth subsystem, or a cellular subsystem (such as a long-term evolution (LTE) or 5th generation (5G) new radio (NR) subsystem). The wireless communication device 200 may include a plurality of antennas 235a, 235b, 235c, or 235d for performing wireless communication with, for example, wireless communication devices in a WPAN.

The wireless communication device 200 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware element, such as a field programmable gate array (FPGA), and/or an application specific integrated circuit (ASIC).

In certain aspects, the radio 230 may include separate controllers configured to control communications for various respective radio access technology (RAT) protocols. For example, as shown in FIG. 2, radio 230 may include a WLAN controller 250 that manages WLAN communications, a Bluetooth controller 252 that manages Bluetooth and BLE communications, and a Wireless Wide Area Network (WWAN) controller 256 that manages WWAN communications. In certain aspects, the wireless communication device 200 may store and execute a WLAN software driver for controlling WLAN operations performed by the WLAN controller 250, a Bluetooth software driver for controlling Bluetooth operations performed by the Bluetooth controller 252, and/or a WWAN software driver for controlling WWAN operations performed by the WWAN controller 256.

In certain implementations, a first coexistence interface 254 (such as a wired interface) may be used for sending information between the WLAN controller 250 and the Bluetooth controller 252. In certain other implementations, a second coexistence interface 258 may be used for sending information between the WLAN controller 250 and the WWAN controller 256. In certain other implementations, a third coexistence interface 260 may be used for sending information between the Bluetooth controller 252 and the WWAN controller 256.

In some aspects, one or more of the WLAN controller 250, the Bluetooth controller 252, and/or the WWAN controller 256 may be implemented as hardware, software, firmware or some combination thereof.

In certain configurations, the WLAN controller 250 may be configured to communicate with a second device in a WPAN using a WLAN link using all of the antennas 235a, 235b, 235c, and 235d. In certain other configurations, the Bluetooth controller 252 may be configured to communicate with at least one second device in a WPAN using one or more of the antennas 235a, 235b, 235c, and 235d. In certain other configurations, the WWAN controller 256 may be configured to communicate with a second device in a WPAN using all of the antennas 235a, 235b, 235c, and 235d. The WLAN controller 250, the Bluetooth controller 252, and/or the WWAN controller 256 may be configured to adjust wakeup time interval and shutdown time for the device.

A short-range wireless communications protocol, such as BT, BLE, and/or BR/EDR, may include and/or may use one or more other communications protocols, for example, for establishing and maintaining communications links. Referring also to FIG. 1, the wireless communication device 200 may establish a communications link 125 with one or more audio devices, such as an earbud 130-a or 130-b, according to at least one communications protocol for short-range wireless communications.

The communications link 125 may include a communications link that adheres to a protocol included and/or for use with BT, BLE, BR/EDR, etc. In one aspect, the communications link 125 may include an asynchronous connection-less (ACL) link. When operating as an ACL link, the communications link 125 may allow the device 115 (e.g., a source device) to connect or “pair” with a peripheral device, such as an audio device (e.g., earbud 130-a or 130-b). The connection is asynchronous in that the two devices may not need to synchronize, time-wise, data communications between each other to permit communication of data packets via the communications link 125.

A Logical Link Control and Adaptation Protocol (L2CAP) may be used within a BT protocol stack (not shown in FIG. 2 for simplicity). An L2CAP connection may be established after an ACL link has been established. Reference to L2CAP in the present disclosure may be further applicable to enhanced L2CAP (EL2CAP), which may be an enhanced version of the L2CAP protocol that enables multiplexing of multiple logical data channels via a single radio connection.

In one aspect, the communications link 125 may include an Advanced Audio Distribution Profile (A2DP) link. An A2DP link provides a point-to-point link between a source device, such as the device 115, and a sync device, such as an audio device (e.g., earbud 130-a or 130-b). With an A2DP link, data packets including audio may be transmitted over an ACL data channel, and other information, for example, for controlling the audio stream, may be transmitted over a separate control channel. The data packets may occur non-periodically.

In another aspect, the communications link 125 may support synchronous logical transport mechanisms between a source device (such as the device 115) and a peripheral device (such as earbud 130-a or 130-b). For example, the communications link 125 may include a synchronous connection-oriented (SCO) link that provides a symmetric point-to-point link between the source device and the peripheral device using time slots reserved for BT communications. In some aspects, an SCO link may not support retransmission of data packets, which may be unsatisfactory in audio streaming and/or voice use cases in which a dropped audio or voice packet may reduce the quality of the user experience.

In a further aspect, the communications link 125 may include an extended SCO (eSCO) link. An eSCO link may provide a symmetric or asymmetric point-to-point link between a source device and a peripheral device using time slots reserved for BT communications, and may also provide for a retransmission window following the reserved time slots. Because retransmissions may be facilitated using the retransmission window, an eSCO link may be suitable for audio streaming and/or voice use cases because a dropped audio or voice packet may be retransmitted, and therefore the probability of successfully receiving a data packet may be increased.

In one aspect, the communications link 125 may include an Isochronous (ISO) link. When operating as an ISO link, the communications link 125 may combine some features of both synchronous and asynchronous links. For example, a stream on an ISO link may begin with a start packet, and then data packets may be asynchronously transmitted. On an ISO link, the number of retransmission attempts by a transmitting device may be limited. Thus, if a receiving device is unable to decode a data packet within the limited number of retransmission attempts, then the data packet may be dropped and the receiving device may continue to receive the stream without data from the dropped data packet.

In some aspects, the audio device includes means for receiving, from a wireless communication device (WCD), an indication that the WCD is in a mute mode; and/or means for transmitting, to the WCD, one or more empty packets based at least in part on the WCD being in the mute mode. In some aspects, the means for the audio device to perform operations described herein may include, for example, one or more of Bluetooth controller 252, WWAN controller 256

[symbol]

In some aspects, the wireless communication device (WCD) includes means for transmitting, to an audio device, an indication that the WCD is in a mute mode; and/or means for receiving, from the audio device, one or more empty packets based at least in part on being in the mute mode. In some aspects, the means for the wireless communication device (WCD) to perform operations described herein may include, for example, one or more of Bluetooth controller 252, WWAN controller 256.

As indicated above, FIG. 2 is provided as an example. Other examples may differ from what is described with regard to FIG. 2.

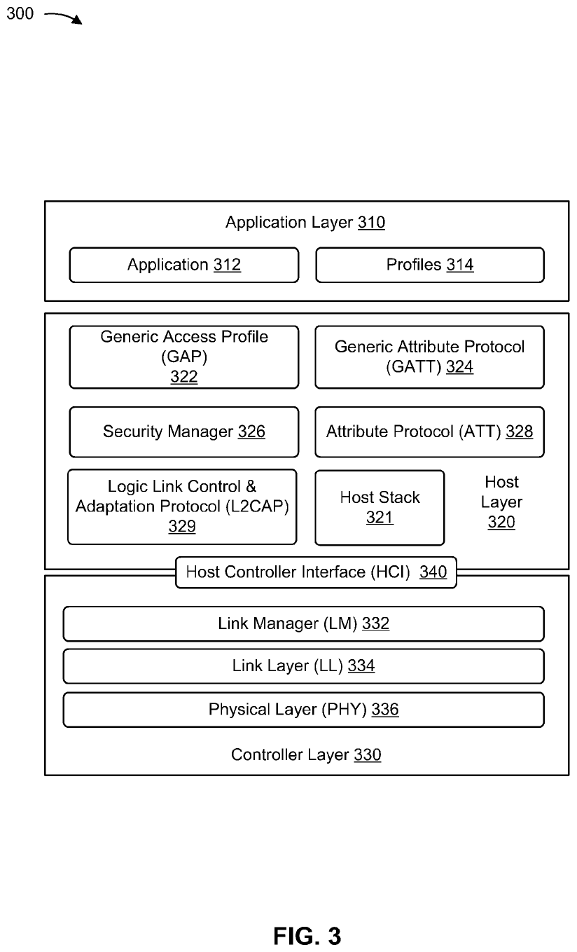

FIG. 3 is a diagram illustrating an example 300 of a protocol stack (e.g., a WPAN and/or a Bluetooth protocol stack), in accordance with the present disclosure. The protocol stack 300 may be implemented in a wireless communication device (such as a device 115 or one or more of the earbuds 130-a or 130-b devices of FIG. 1). For example, the BT protocol stack 300 may be implemented by one or more of processor(s) 202, memory 206, flash memory 210, ROM 208, the radio 230, and/or the Bluetooth controller 252 illustrated in FIG. 2. The BT protocol stack 300 may be organized into three layers including an application layer 310, a host layer 320, and a controller layer 330.

The application layer 310 may be a user application that interfaces with the other blocks and/or layers of the BT protocol stack 300. In some aspects, the application layer 310 may include one or more applications 312 and one or more Bluetooth profiles 314 that allow the applications to use the Bluetooth and BLE communications. The host layer 320 may include the upper layers of the BT protocol stack 300, and may communicate with a controller (such as the Bluetooth controller 252 of FIG. 2) in a wireless communication device using a host controller interface (HCl) 340. In some aspects, the host layer 320 may include a host stack 321 that can be used for application layer interface management to allow an application to access Bluetooth communications.

The controller layer 330 may include the lower layers of the BT protocol stack 300. The controller layer 330, which may be used for hardware interface management, link establishment, and link management, is shown to include a link manager (LM) 332, a link layer (LL) 334, and a physical (PHY) layer 336. The PHY layer 336 may include, for example, a radio and/or a baseband processor. In some aspects, the PHY layer 336 may define the mechanism for transmitting a bit stream over a physical link or channel that connects BT devices. The bit stream may be grouped into code words or symbols, and converted to a data packet that is transmitted over a wireless transmission medium. The PHY layer 336 may provide an electrical, mechanical, and/or procedural interface to the wireless transmission medium. The PHY layer 336 may be responsible for modulation and demodulation of data into radio frequency (RF) signals for transmission over the air. The PHY layer 336 may describe the physical characteristics of a wireless communication device's receiver/transmitter. The physical characteristics may include modulation characteristics, radio frequency tolerance, sensitivity level, etc.

The link layer 334 is responsible for low-level communication over the PHY layer 336. The link layer 334 334 manages the sequence and timing for transmitting and receiving data packets, and using a LL protocol, communicates with other devices regarding connection parameters and data flow control. The link layer 334 also provides gatekeeping functionality to limit exposure and data exchange with other devices. If filtering is configured, the link layer 334 maintains a list of allowed devices and will ignore all requests for data exchange from devices not on the list. The link layer 334 may also reduce power consumption. In some aspects, the link layer 334 may include a company's proprietary LL that may be used to discover peer devices, and establish a secure communication channel therewith. In certain aspects, the link layer 334 may be responsible for transporting data packets between devices in a WPAN. Each data packet may include an access address, which specifies the type of logical transport used to carry the data packet. Logical transports may exist between a master device and slave devices. Additionally, some logical transports may carry multiple logical links.

The link manager 332 may be responsible for establishing and configuring links and managing power-change requests, among other tasks. Each type of logical link, such as ACL links, A2DP links, SCO links, eSCO links, ISO links, etc., may be associated with a specific packet type. For example, an SCO link may provide reserved channel bandwidth for communication between a master device and a slave device, and support regular, periodic exchange of data packets with no retransmissions. An eSCO link may provide reserved channel bandwidth for communication between a source device and a peripheral device, and support regular, periodic exchange of data packets with retransmissions. An ACL link may exist between a source device and a peripheral device from the beginning of establishment of a connection between the source device and the peripheral device, and the data packets for ACL links may include encoding information in addition to a payload.

The link manager 332 may communicate with the host layer 320 using the HCl 340. In some instances, the link manager 332 may translate HCl 340 commands into controller-level operations, such as baseband-level operations. The HCl 340 may act as a boundary between the lower layers (such as between the controller layer 330, the host layer 320, and the application layer 310). The BT specification may define a standard HCl to support BT systems that are implemented across two separate processors. For example, a BT system on a computer may use the BT system's own processor to implement the lower layers of the BT protocol stack 300, such as the PHY layer 336, the link layer 334, and/or the link manager 332. In some aspects, the BT system may use a processor of a BT component to implement the other layers of the BT protocol stack 300 such as, for example, the host layer 320 and the application layer 310.

The host layer 320 is shown to include a general access profile (GAP) 322, a generic attribute protocol (GATT) 324, a security manager (SM) 326, attribute protocol (ATT) 328, and a L2CAP layer 329. The GAP 322 may provide an interface for the application 312 to initiate, establish, and manage connections with other BT or BLE devices. The GATT 324 may provide a service framework using the attribute protocol for discovering services, and for reading and writing characteristic values on a peer device. The GATT 324 may interface with the application 312, for example, through a profile which may define a collection of attributes and any permission needed for the attributes to be used in BT or BLE communications.

The security manager 326 may be responsible for device pairing and key distribution. A security manager protocol implemented by the security manager 326 may define how communications with the security manager of a counterpart BLE device are performed. The security manager 326 provides additional cryptographic functions that may be used by other components of the BT protocol stack 300. The architecture of the security manager 326 used in Bluetooth communications is designed to minimize recourse requirements for peripheral devices by shifting work to an assumingly more powerful central device. BLE uses a pairing mechanism for key distribution. The security manager 326 provides a mechanism to not only encrypt the data but also to provide data authentication.

The ATT 328 includes a client/server protocol based on attributes associated with a BLE device configured for a particular purpose. Examples may include monitoring heart rate, temperature, broadcasting advertisements, etc. The attributes may be discovered, read, and written by peer devices. The set of operations which are executed over ATT 328 may include, but are not limited to, error handling, server configuration, find information, read operations, write operations, queued writes, etc. The ATT 328 may form the basis of data exchange between BT and BLE devices.

The L2CAP layer 329 may be implemented above the HCl 340, and may communicate with the controller layer 330 through the HCl 340. The L2CAP layer 329 may be primarily responsible for establishing connections across one or more existing logical links and for requesting additional links if none exist. The L2CAP layer 329 may also implement multiplexing between different higher-layer protocols, for example, to allow different applications to use a single link, such as a logical link, including an ACL link. In some implementations, the L2CAP layer 329 may encapsulate multiple protocols from the upper layers into a data packet format (and vice versa). The L2CAP layer 329 may also break packets with a large data payload from the upper layers into multiple packets with the data payload segmented into smaller size data payloads that fit into a maximum payload size (for example, 27 bytes) on the transmit side.

In some standards and protocols, such as BLE and/or BR/EDR, the device 115 may detect errors in a packet and/or a dropped/missed/not received packet through the use of cyclic redundancy check (CRC) validation and through the use of message integrity code (MIC) validation. MIC validation may be used when a packet is encrypted. For example, failure of CRC validation may indicate one or more errors in a received packet and failure of MIC validation may indicate that another packet has not been received (although failure of CRC validation may also indicate that another packet has not been received and/or failure of MIC validation may also indicate one or more errors in a received packet).

CRC validation and MIC validation may be based on generating CRC values and MICs, respectively, based on received packets and respectively comparing those generated CRC values and MICs to CRC and MICs included in received packets. Specifically, a receiving device, such as earbud 130-a or 130-b, that receives a packet may first generate a CRC value or a CRC checksum based on the received packet, such as based on a payload and, if applicable, an MIC included in the received packet. The receiving device may compare the generated CRC value with a CRC value included in the received packet. If the generated CRC value matches the CRC value included in the received packet, then the received packet may be validated for CRC. The CRC-validated received packet may then be decrypted. However, if the generated CRC value does not match the CRC value included in the received packet, then the receiving device may determine that the received packet fails CRC validation. If the receiving device determines the received packet fails CRC validation, then the received packet may include errors and/or may be corrupted. In one configuration, the receiving device may discard the received packet that fails CRC validation; however, in another configuration, the receiving device may attempt to recover the received packet using, for example, one or more error correction techniques.

If the received packet is encrypted and passes CRC validation, then the receiving device may decrypt the received packet to obtain a decrypted payload and a decrypted MIC. For MIC validation, the receiving device may generate an MIC based on the decrypted payload, and compare the generated MIC with the MIC obtained from the decrypted received packet. If the generated MIC matches the decrypted MIC, then the receiving device may determine that the received packet is successfully decrypted. When the received packet is successfully decrypted, the decoded and decrypted payload of the received packet may be provided to another layer of the receiving device, such as a coder-decoder (codec) of the receiving device that may cause the payload data of the received packet to be output by the receiving device as, for example, audio through speakers of the earbud 130-a or 130-b.

If the generated MIC does not match the decrypted MIC of the received packet, then the receiving device may determine that the received packet is unsuccessfully decrypted. When the received packet is unsuccessfully decrypted, then a different packet may have been missed or the received packet may be erroneous or otherwise corrupted. In one configuration, the receiving device may discard the received packet that fails MIC validation; however, in another configuration, the receiving device may attempt to recover the received packet.

As indicated above, FIG. 3 is provided as an example. Other examples may differ from what is described with regard to FIG. 3.

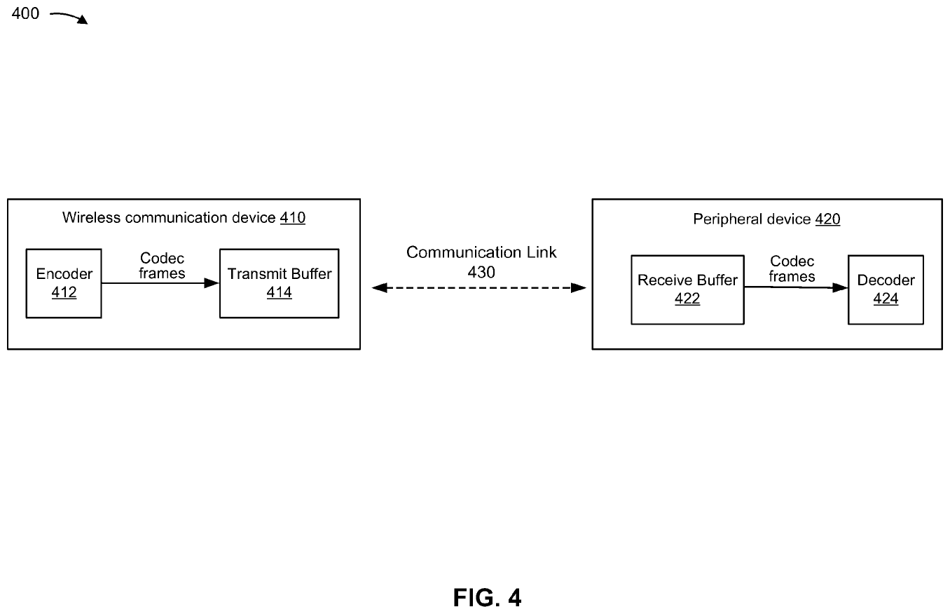

FIG. 4 depicts an example transmission 400 of data packets from a wireless communication device 410 to a peripheral device 420 over a communication link 430, according to various aspects of the present disclosure. In some implementations, the wireless communication device 410 may be one example of the device 115 of FIG. 1, or the wireless communication device 200 of FIG. 2, and the peripheral device 420 may be an example of one or more of the earbuds 130-a or 130-b of FIG. 1 or another audio device. In some instances, the peripheral device 420 may be a pair of earbuds. The communication link 430 may be any suitable Bluetooth connection or link. In some instances, the communication link 430 may be one or more of an asynchronous connection-less (ACL) link, a Logical Link Control and Adaptation Protocol (L2CAP) link, an Advanced Audio Distribution Profile (A2DP) link, a synchronous connection-oriented (SCO) link, or an isochronous (ISO) link.

The wireless communication device 410 is shown to include an encoder 412 and a transmit buffer 414. The encoder 412 may be configured to encode data, such as audio or video data, using a specified bitrate. The transmit buffer 414 may be configured to queue data packets that are to be transmitted over the communication link 430 to the peripheral device 420. In some implementations, the data packets to be transmitted over the communication link 430 may be of a predefined size based, for example, on the type of communication link 430 and/or channel conditions associated with the communication link 430. In some aspects, data encoded by the encoder 412 may be packetized into a data packet of a predefined size. The wireless communication device 410 may de-queue data packets from the transmit buffer 414 and transmit the data packets to the peripheral device 420 over the communication link 430.

The peripheral device 420 is shown to include a receive buffer 422 and a decoder 424. Data packets received over the communication link 430 may be queued or otherwise stored in the receive buffer 422. The data packets may be output from the receive buffer 422 and forwarded to the decoder 424. In some aspects, the decoder 424 may decode data (such as audio and/or video data) carried in the payloads of the queued data packets, and forward the decoded data to upper layers of the protocol stack for processing and playback to a user. In some implementations, the encoder 412 may encode a first encoder/decoder (codec) frame using a first bitrate, and forward the first codec frame to the transmit buffer 414 to be packetized for transmission to the peripheral device 420 over the communication link 430. The peripheral device 420 may queue the received data packet in the receive buffer 422, and may forward the first portion of the first codec frame to the decoder 424 for decoding.

As indicated above, FIG. 4 is provided as an example. Other examples may differ from what is described with regard to FIG. 4.

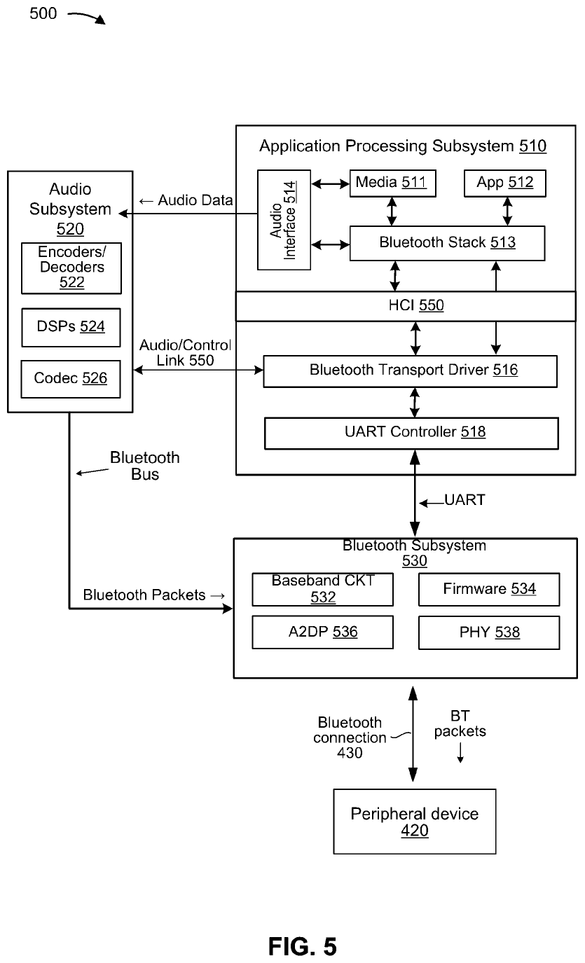

FIG. 5 shows a block diagram of another example wireless communication device 500, according to various aspects of the present disclosure. In some implementations, the wireless communication device 500 may be an example of the device 115 of FIG. 1, the wireless communication device 200 of FIG. 2, or the wireless communication device 410 of FIG. 4. In the example of FIG. 5, the wireless communication device 500 is depicted as having an established communication link 430 (e.g., a Bluetooth communication connection) with the peripheral device 420 of FIG. 4.

The wireless communication device 500 may include an Application Processing subsystem 510, an audio subsystem 520, a Bluetooth subsystem 530, and a Host Controller Interface (HCl) 550. The Application Processing subsystem 510, which may correspond to at least some portions of the application layer 310 and the host layer 320 of the BT protocol stack 300 of FIG. 3, is shown to include a media player 511, an Application Layer (App) 512, a Bluetooth stack 513, and an audio interface 514. The media player 511 can be suitable device or component capable of generating or receiving multimedia content including, for example, real-time audio streams, real-time video streams, real-time gaming streams, and other latency-sensitive traffic. The App 512, which may be one implementation of the application layer 310 of FIG. 3, includes at least one Bluetooth profile that defines the collection of attributes and associated permissions to be used in Bluetooth or BLE communications. In some aspects, the App 512 may include processing resources including (but not limited to) the memory 206, the ROM 208, and the Flash memory 210 of FIG. 2. The Bluetooth stack 513 may be one implementation of the BT protocol stack 300 of FIG. 3.

The Bluetooth transport driver 516 may include a split audio and packetization module (not shown for simplicity) that can packetize data (such as audio and/or video data) into Bluetooth frames that can be transmitted to the peripheral device 420 using either a Bluetooth or BLE protocol.

The Bluetooth transport driver 516 is connected to the audio subsystem 520 via an audio and control link 550. In some instances, the audio and control link 550 may be used to send encoded audio/video data and control signals between the Bluetooth transport driver 516 and audio/video digital signal processors (DSPs) within the audio subsystem 520.

The Bluetooth transport driver 516 is connected to a universal asynchronous receiver-transmitter (UART) controller 518 that provides controls for transmission of information via a Bluetooth connection.

The audio subsystem 520 may include encoders/decoders 522, one or more digital signal processors (DSPs) 524, and one or more codecs 526. The encoders/decoders 522 may be used to sample audio/video data extracted from one or more packets received from another wireless communication device. The extracted audio/video data may be processed in the Application Processing Subsystem 510 based at least in part on the Bluetooth profile. In some implementations, the encoders/decoders 522 may partition the sampled audio/video data into payloads that can be embedded within one or more Bluetooth packets for transmission to the peripheral device 420 over a Bluetooth or BLE connection. In some instances, the DSPs 524 and/or the codecs 526 may employ one or more encoding or decoding algorithms in conjunction with sampling the audio data.

The Bluetooth subsystem 530 may include a baseband circuit (CKT) 532 (e.g., Bluetooth baseband circuit), Bluetooth firmware 534, an advanced audio distribution profile (A2DP) circuit 536, and a PHY 538. The baseband circuit 532 and the Bluetooth firmware 534 may be used to generate baseband signals for constructing and deconstructing data frames based on the Bluetooth or BLE protocol. The baseband circuit 532 and the Bluetooth firmware 534 may also be used to generate carrier signals for up-converting baseband signals during data transmissions and for down-converting received data signals to baseband. The A2DP circuit 536 may be used to control or manage an A2DP link between the wireless communication device 500 and the peripheral device 420. Specifically, when the Bluetooth subsystem 530 is in a receive mode, the PHY 538 can be used to receive, demodulate, and down-convert data packets received over the communication link 430, and to forward the data packets to the Application Processing subsystem 510. When the Bluetooth subsystem 530 is in a transmit mode, the PHY 538 can be used to encapsulate data provided from the upper layers into one or more Bluetooth frames or packets for transmission to the peripheral device 420 over the communication link 430.

As indicated above, FIG. 5 is provided as an example. Other examples may differ from what is described with regard to FIG. 5.

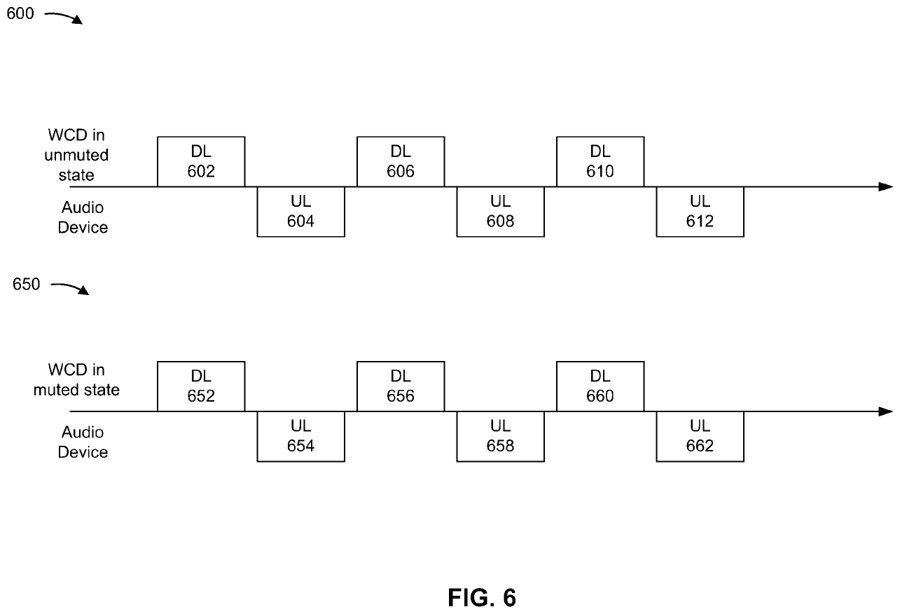

FIG. 6 illustrates examples 600 and 650 of a wireless communications link, in accordance with one or more aspects of the present disclosure. In the context of FIG. 6, a WCD (e.g., device 105) may communicate with an audio device (e.g., a wireless earbud 130) via an audio link.

As shown in example 600, the WCD and the audio device may communicate with the WCD in an unmuted state. The WCD may provide a downlink (DL) communication 602 to the audio device and the audio device may provide an uplink (UL) communication 604 to the WCD. The UL communication 604 may include audio data obtained and encoded by the audio device for transmission as a connected isochronous stream (CIS) of packets. For example, a microphone of the audio device may capture audio input via a microphone and may transmit the audio input to the WCD.

The WCD may use the audio input in communications with another device. For example, the WCD may be connected to an additional device (e.g., via the internet or another network) for an audio and/or video call. The WCD may provide the audio input that is captured by the audio device to the additional device as part of the audio and/or video call.

The WCD and the audio device may continue to exchange UL and DL communications as part of the audio and/or video call, as shown by DL communication 606, UL communication 608, DL communication 610, and UL communication 612.

As shown in example 650, the WCD and the audio device may communicate with the WCD in a muted state. The WCD may provide a DL communication 652 to the audio device and the audio device may provide a UL communication 654 to the WCD. However, based at least in part on the WCD being in a muted state (e.g., for communication with the additional device), the WCD may discard the audio input without transmitting the audio input to the additional device.

The WCD and the audio device may continue to exchange UL and DL communications as part of the audio and/or video call, as shown by DL communication 656, UL communication 658, DL communication 660, and UL communication 662.

Each of the UL communications 654 and 658 may unnecessarily consume power, computing, and communication resources of the audio device based at least in part on capturing and transmitting audio data that is not used for a communication link of the WCD based at least in part on being in a mute mode.

As indicated above, FIG. 6 is provided as an example. Other examples may differ from what is described with respect to FIG. 6.

In some aspects described herein, a WCD (e.g., a central device, a host device, a STA, or another computer) may send an indication to an audio device (e.g., via a BLE link) that the WCD is initiating a mute mode or an unmute mode. For example, the WCD may initiate the mute mode or the unmute mode (e.g., returning from a mute mode) based at least in part on receiving input from a user or an additional device in communication with the WCD via a communication stream (e.g., an audio and/or video call).

The audio device (e.g., a peripheral device, such as an earbud) may send empty packets (e.g., CIS packets), disable a microphone of the audio device, and/or disable an encoder and related algorithm based at least in part on receiving an indication that the WCD is initiating the mute mode. Similarly, the audio device may send audio data, enable the microphone of the audio device, and/or enable the encoder and related algorithm based at least in part on receiving an indication that the WCD is exiting the mute mode (e.g., initiating an unmute mode).

Based at least in part on the audio device disabling one or more functions and/or transmitting one or more empty packets when the WCD is in the mute mode, the audio device may conserve power, computing, and communication resources of the audio device that may have otherwise been used to capture and transmit audio data that is not used for a communication link of the WCD based at least in part on being in a mute mode.

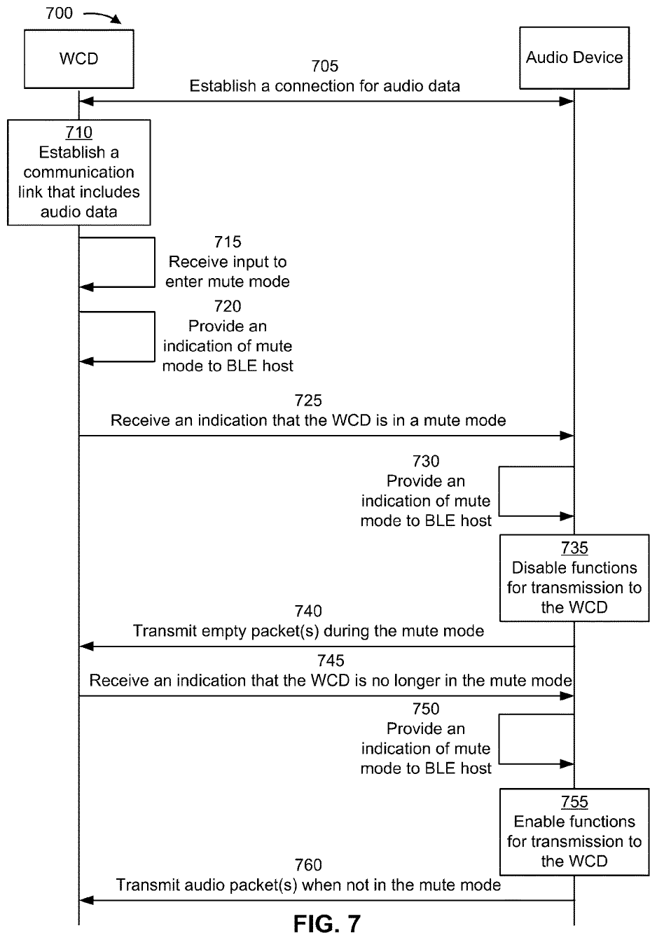

FIG. 7 is a diagram of an example 700 associated with a mute mode operation of an audio device, in accordance with the present disclosure. As shown in FIG. 7, a WCD (e.g., a UE, a host device, and/or and audio source, among other examples) may communicate with an audio device (e.g., 130-a or 130-b).

As shown by reference number 705, the WCD and the audio device may establish a connection for audio data. In some aspects, the connection may include a first link associated with BLE information (e.g., control information) and a second link associated with audio data (e.g., audio data for presentation by the audio device and audio data captured by the audio device for transmission to the WCD).

As shown by reference number 710, the WCD may establish a communication link that includes audio data. For example, the WCD may establish an audio and/or video call with one or more additional devices. In some aspects, the WCD may be a member of a virtual meeting with multiple additional devices. In the virtual meeting, the WCD and/or one or more of the multiple additional devices may be muted (e.g., to stop transmission of audio data) to reduce background noise when one of the multiple additional devices provides audio data for presentation to the WCD and the multiple additional devices.

As shown by reference number 715, the WCD may receive input to enter a mute mode. In some aspects, the WCD may receive the input to enter the mute mode from a user of the WCD or from an additional device (e.g., a meeting host) associated with the communication link. The mute mode may be associated with an audio stream from the WCD to the one or more additional devices.

As shown by reference number 720, the WCD may provide an indication of the mute mode to a BLE host of the WCD (e.g., host layer 320 and/or a host stack 321, among other examples).

As shown by reference number 725, the audio device may receive, and the WCD may transmit, an indication that the WCD is in a mute mode. In some aspects, the WCD may transmit the indication that the WCD is in the mute mode via a first link (e.g., a low energy link, such as a BLE link) that is separate from a second link associated with communication of audio data. The first link may use a different communication protocol, a different frequency bandwidth, and/or a different channel from the second link.

As shown by reference number 730, the audio device may provide an indication of the mute mode to a BLE host of the audio device (e.g., host layer 320 and/or a host stack 321, among other examples).

As shown by reference number 735, the audio device may disable one or more functions for transmission to the WCD. In some aspects, disabling the one or more functions of the audio device may include disabling the one or more functions that are associated with communication with the WCD (e.g., capturing and providing audio data to the WCD). In some aspects, the one or more functions may be associated with a microphone of the audio device, an encoder of the audio device, and/or an uplink audio data processor of the audio device.

As shown by reference number 740, the audio device may transmit, and the WCD may receive, one or more empty packets during the mute mode. In some aspects, the audio device may transmit the one or more empty packets via the second link. In some aspects, the one or more empty packets may include one or more packets without audio data from a microphone of the audio device. For example, the one or more empty packets may include one or more headers, synchronization information, and/or other overhead-based information. In some aspects, the one or more empty packets do not include audio data from a microphone of the audio device, encoded data, and/or CIS data packets that are based at least in part on captured audio data, among other examples.

In some aspects, the one or more empty packets may occupy a reduced air time relative to a packet having data. For example, an audio packet may include about 300 microseconds and an empty packet may include about 44 microseconds. Based at least in part on occupying a reduced air time, the audio device and the WCD may conserve network, power, computing, and communication resources that may have otherwise been used to communication audio packets.

As shown by reference number 745, the audio device may receive, and the WCD may transmit, an indication that the WCD is no longer in a mute mode. For example, the indication may initiate an unmute mode.

As shown by reference number 750, the audio device may provide an indication of the mute mode (e.g., an indication of a status of the WCD as being in an unmute mode or that the WCD is no longer in the mute mode) to a BLE host of the audio device (e.g., host layer 320 and/or a host stack 321, among other examples).

As shown by reference number 755, the audio device may enable one or more functions for transmission to the WCD. In some aspects, enabling the one or more functions of the audio device may include enabling the one or more functions that are associated with communication with the WCD (e.g., capturing and providing audio data to the WCD). In some aspects, the one or more functions may be associated with a microphone of the audio device, an encoder of the audio device, and/or an uplink audio data processor of the audio device.

As shown by reference number 760, the audio device may transmit, and the WCD may receive, one or more audio packets when not in the mute mode (e.g., in the unmute mode).

Based at least in part on the audio device disabling one or more functions and/or transmitting one or more empty packets when the WCD is in the mute mode, the audio device may conserve power, computing, and communication resources of the audio device that may have otherwise been used to capture and transmit audio data that is not used for a communication link of the WCD based at least in part on being in a mute mode.

As indicated above, FIG. 7 is provided as an example. Other examples may differ from what is described with respect to FIG. 7.

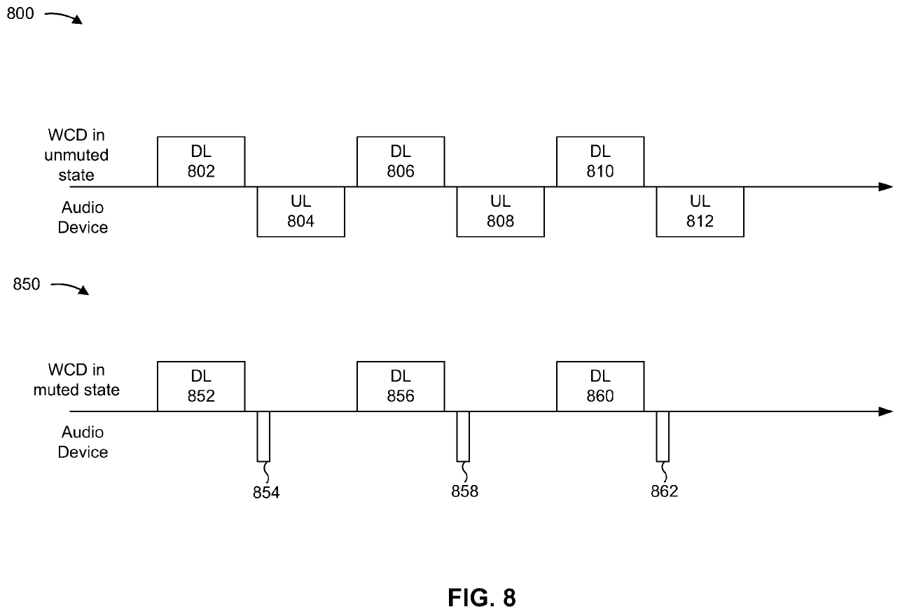

FIG. 8 illustrates examples 800 and 850 of a wireless communications link, in accordance with one or more aspects of the present disclosure. In context of FIG. 8, a WCD (e.g., device 105) may communicate with an audio device (e.g., a wireless earbud 130) via an audio link.

As shown in example 800, the WCD and the audio device may communicate with the WCD in an unmuted state. The WCD may provide a DL communication 802 to the audio device and the audio device may provide a UL communication 804 to the WCD. The UL communication 804 may include audio data obtained and encoded by the audio device for transmission as a CIS of packets. For example, a microphone of the audio device may capture audio input via a microphone and may transmit the audio input to the WCD.

The WCD may use the audio input in communications with another device. For example, the WCD may be connected to an additional device (e.g., via the internet or another network) for an audio and/or video call. The WCD may provide the audio input that is captured by the audio device to the additional device as part of the audio and/or video call.

The WCD and the audio device may continue to exchange UL and DL communications as part of the audio and/or video call, as shown by DL communication 806, UL communication 808, DL communication 810, and UL communication 812.

As shown in example 850, the WCD and the audio device may communicate with the WCD in a muted state. The WCD may provide a DL communication 852 to the audio device and the audio device may provide an empty packet 854 to the WCD. The empty packet 854 may have a reduced air time relative to the UL communication 804 based at least in part on not carrying audio data in a payload. In this way, the WCD and the audio device may conserve power and computing resources that may have otherwise been used to communicate audio data that would be discarded based at least in part on the WCD being in the mute mode.

The WCD and the audio device may continue to exchange DL communications and empty packets as part of the audio and/or video call, as shown by DL communication 856, empty packet 858, DL communication 860, and empty packet 862.

As indicated above, FIG. 8 is provided as an example. Other examples may differ from what is described with respect to FIG. 8.

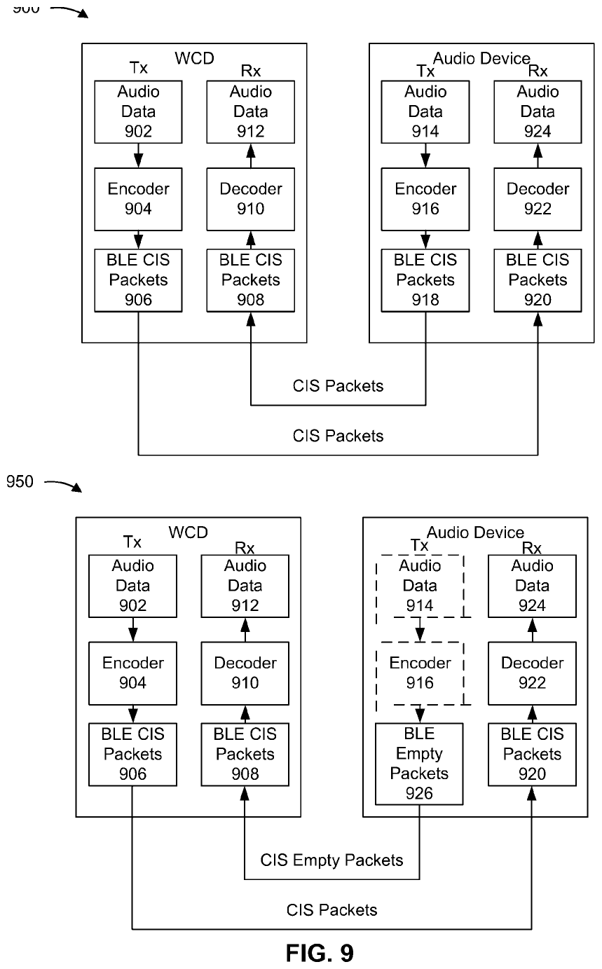

FIG. 9 illustrates examples 900 and 950 of a wireless communications link, in accordance with one or more aspects of the present disclosure. In context of FIG. 9, a WCD (e.g., device 105) may communicate with an audio device (e.g., a wireless earbud 130) via an audio link.

As shown in example 900, the WCD may have a transmission chain for communication with the audio device. The transmission chain may include providing audio data 902 to an encoder 904. The encoder 904 may encode the audio data 902 into BLE CIS packets 906 for transmission to the audio device.

The WCD may also have a reception chain for communication with the audio device. The reception chain may include reception of BLE CIS packets 908 that are provided to a decoder 910 that decodes the BLE CIS packets 908 into audio data 912.

The audio device may have a transmission chain for communication with the WCD. The transmission chain may include providing audio data 914 to an encoder 916. The encoder 916 may encode the audio data 914 into BLE CIS packets 918 for transmission to the WCD (e.g., to the reception chain of the WCD).

The audio device may also have a reception chain for communication with the WCD. The reception chain may include reception of BLE CIS packets 920 that are provided to a decoder 922 that decodes the BLE CIS packets 920 into audio data 924.

As shown in example 950, the audio device may disable capturing and/or generating the audio data 914. For example, the audio device may disable a microphone configured to capture audio data to provide to the WCD. Additionally, or alternatively, the audio device may disable the encode 916.

Based at least in part on the WCD being in the mute mode and the WCD indicating the mute mode to the audio device, the audio device may transmit BLE empty packets 926 to the WCD in place of the BLE CIS packets 918 that may have otherwise been transmitted to the WCD. The BLE empty packets 926 may occupy reduced air time and/or may exclude audio data relative to the BLE CIS packets 918.

As indicated above, FIG. 9 is provided as an example. Other examples may differ from what is described with respect to FIG. 9.

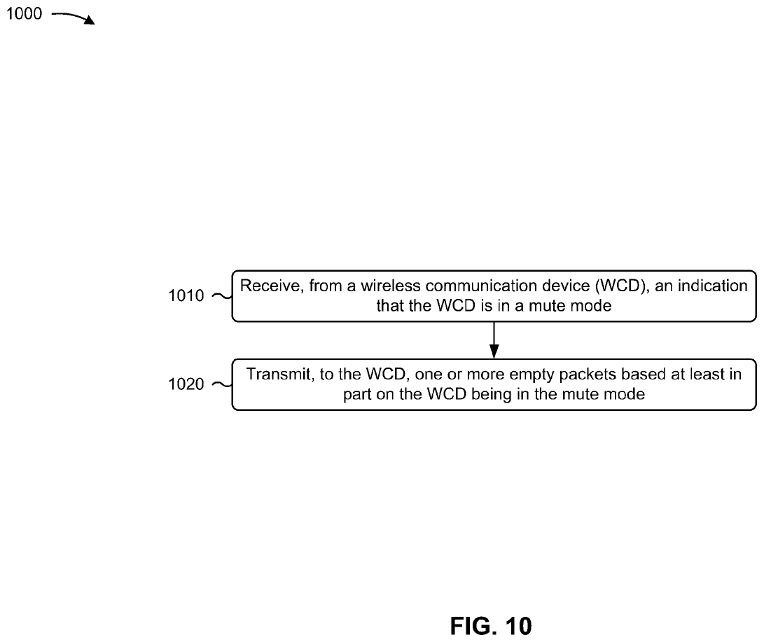

FIG. 10 is a diagram illustrating an example process 1000 performed, for example, by an audio device, in accordance with the present disclosure. Example process 1000 is an example where the audio device (e.g., earbud 130) performs operations associated with mute mode operation of an audio device.

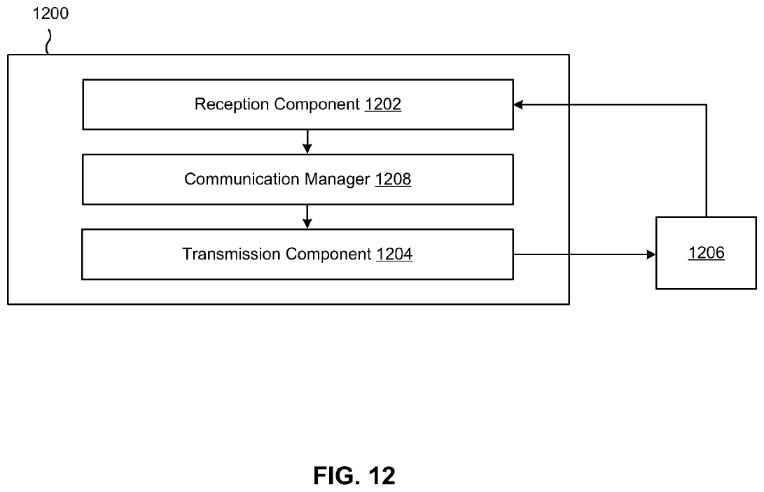

As shown in FIG. 10, in some aspects, process 1000 may include receiving, from a WCD, an indication that the WCD is in a mute mode (block 1010). For example, the audio device (e.g., using reception component 1202 and/or communication manager 1208, depicted in FIG. 12) may receive, from a WCD, an indication that the WCD is in a mute mode, as described above.

As further shown in FIG. 10, in some aspects, process 1000 may include transmitting, to the WCD, one or more empty packets based at least in part on the WCD being in the mute mode (block 1020). For example, the audio device (e.g., using transmission component 1204 and/or communication manager 1208, depicted in FIG. 12) may transmit, to the WCD, one or more empty packets based at least in part on the WCD being in the mute mode, as described above.

Process 1000 may include additional aspects, such as any single aspect or any combination of aspects described below and/or in connection with one or more other processes described elsewhere herein.

In a first aspect, receiving the indication that the WCD is in the mute mode comprises receiving the indication via a first link, and transmitting the one or more empty packets comprises transmitting the one or more empty packets via a second link that is different from the first link.

In a second aspect, alone or in combination with the first aspect, the first link comprises a low energy link, and the second link comprises an audio link.

In a third aspect, alone or in combination with one or more of the first and second aspects, process 1000 includes disabling, for communication with the WCD and based at least in part on the WCD being in the mute mode, one or more of a microphone, an encoder, or uplink audio data processing.

In a fourth aspect, alone or in combination with one or more of the first through third aspects, the one or more empty packets comprise one or more packets without audio data from a microphone of the audio device.

In a fifth aspect, alone or in combination with one or more of the first through fourth aspects, transmitting the one or more empty packets comprises transmitting the one or more empty packets with a reduced air time relative to a packet having audio data.

In a sixth aspect, alone or in combination with one or more of the first through fifth aspects, process 1000 includes receiving, from the WCD and after transmitting the one or more empty packets, an indication that the WCD is no longer in the mute mode, and transmitting, to the WCD, one or more packets with audio data.

In a seventh aspect, alone or in combination with one or more of the first through sixth aspects, the mute mode is associated with an audio stream from the WCD to an additional device.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

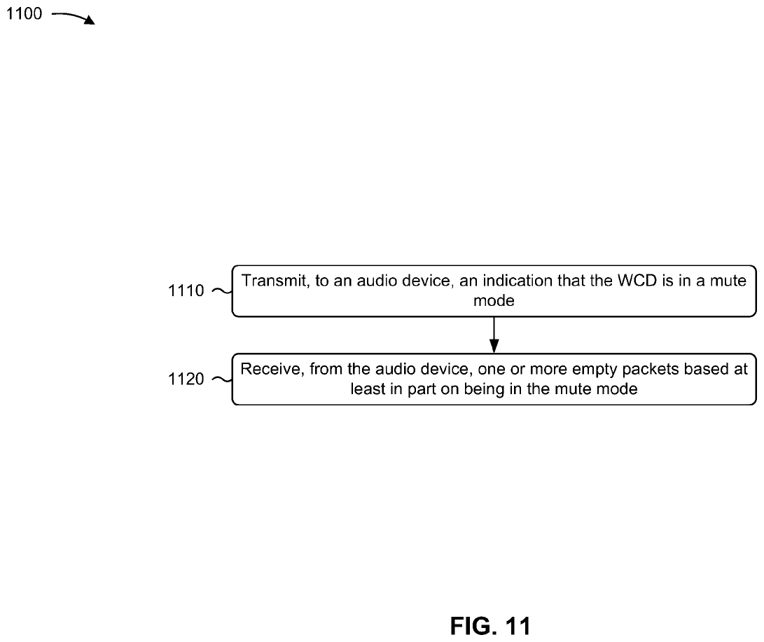

FIG. 11 is a diagram illustrating an example process 1100 performed, for example, by a WCD, in accordance with the present disclosure. Example process 1100 is an example where the WCD (e.g., WCD 115) performs operations associated with mute mode operation of an audio device.

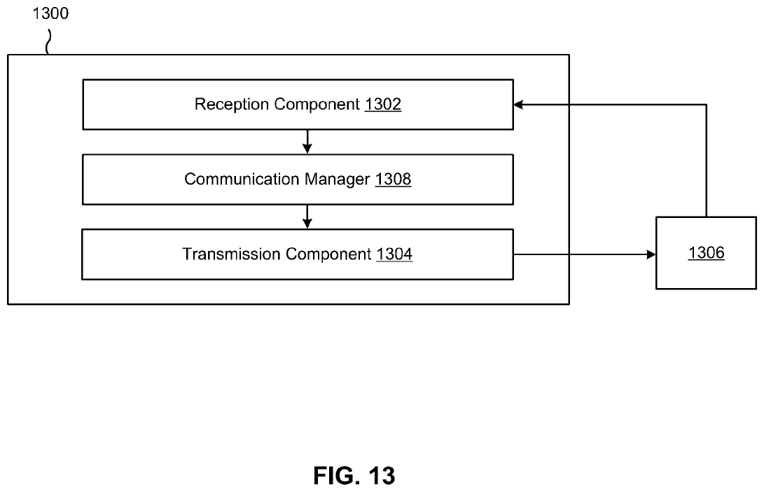

As shown in FIG. 11, in some aspects, process 1100 may include transmitting, to an audio device, an indication that the WCD is in a mute mode (block 1110). For example, the WCD (e.g., using transmission component 1304 and/or communication manager 1308, depicted in FIG. 13) may transmit, to an audio device, an indication that the WCD is in a mute mode, as described above.

As further shown in FIG. 11, in some aspects, process 1100 may include receiving, from the audio device, one or more empty packets based at least in part on being in the mute mode (block 1120). For example, the WCD (e.g., using reception component 1302 and/or communication manager 1308, depicted in FIG. 13) may receive, from the audio device, one or more empty packets based at least in part on being in the mute mode, as described above.

Process 1100 may include additional aspects, such as any single aspect or any combination of aspects described below and/or in connection with one or more other processes described elsewhere herein.

In a first aspect, transmitting the indication that the WCD is in the mute mode comprises receiving the indication via a first link, wherein receiving the one or more empty packets comprises transmitting the one or more empty packets via a second link that is different from the first link.

In a second aspect, alone or in combination with the first aspect, the first link comprises a low energy link, and the second link comprises an audio link.

In a third aspect, alone or in combination with one or more of the first and second aspects, process 1100 includes disabling, for communication with the WCD and based at least in part on the WCD being in the mute mode, one or more of a microphone, an encoder, or uplink audio data processing.

In a fourth aspect, alone or in combination with one or more of the first through third aspects, the one or more empty packets comprise one or more packets without audio data from a microphone of the audio device.

In a fifth aspect, alone or in combination with one or more of the first through fourth aspects, transmitting the one or more empty packets comprises transmitting the one or more empty packets with a reduced air time relative to a packet having audio data.

In a sixth aspect, alone or in combination with one or more of the first through fifth aspects, process 1100 includes receiving, from the WCD and after transmitting the one or more empty packets, an indication that the WCD is no longer in the mute mode, and transmitting, to the WCD, one or more packets with audio data.

In a seventh aspect, alone or in combination with one or more of the first through sixth aspects, the mute mode is associated with an audio stream from the WCD to an additional device.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a audio device, or a audio device may include the apparatus 1200. In some aspects, the apparatus 1200 includes a reception component 1202, a transmission component 1204, and/or a communication manager 1208, which may be in communication with one another (for example, via one or more buses and/or one or more other components). As shown, the apparatus 1200 may communicate with another apparatus 1206, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the audio device described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a multiple-input multiple-output (MIMO) detector, a receive processor, a controller/processor, a memory, or a combination thereof, of the audio device described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the audio device described in connection with FIG. 2. In some aspects, the transmission component 1204 may be co-located with the reception component 1202 in a transceiver.

The communication manager 1208 may support operations of the reception component 1202 and/or the transmission component 1204. For example, the communication manager 1208 may receive information associated with configuring reception of communications by the reception component 1202 and/or transmission of communications by the transmission component 1204. Additionally, or alternatively, the communication manager 1208 may generate and/or provide control information to the reception component 1202 and/or the transmission component 1204 to control reception and/or transmission of communications.

The reception component 1202 may receive, from a WCD, an indication that the WCD is in a mute mode. The transmission component 1204 may transmit, to the WCD, one or more empty packets based at least in part on the WCD being in the mute mode.

The communication manager 1208 may disable, for communication with the WCD and based at least in part on the WCD being in the mute mode, one or more of a microphone, an encoder, or uplink audio data processing.

The reception component 1202 may receive, from the WCD and after transmitting the one or more empty packets, an indication that the WCD is no longer in the mute mode.

The transmission component 1204 may transmit, to the WCD, one or more packets with audio data.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a WCD, or a WCD may include the apparatus 1300. In some aspects, the apparatus 1300 includes a reception component 1302, a transmission component 1304, and/or a communication manager 1308, which may be in communication with one another (for example, via one or more buses and/or one or more other components). As shown, the apparatus 1300 may communicate with another apparatus 1306, such as a UE or a network node, using the reception component 1302 and the transmission component 1304.

In some aspects, the apparatus 1300 may be configured to perform one or more operations described herein in connection with FIGS. 7-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the WCD described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the WCD described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the WCD described in connection with FIG. 2. In some aspects, the transmission component 1304 may be co-located with the reception component 1302 in a transceiver.

The communication manager 1308 may support operations of the reception component 1302 and/or the transmission component 1304. For example, the communication manager 1308 may receive information associated with configuring reception of communications by the reception component 1302 and/or transmission of communications by the transmission component 1304. Additionally, or alternatively, the communication manager 1308 may generate and/or provide control information to the reception component 1302 and/or the transmission component 1304 to control reception and/or transmission of communications.

The transmission component 1304 may transmit, to an audio device, an indication that the WCD is in a mute mode. The reception component 1302 may receive, from the audio device, one or more empty packets based at least in part on being in the mute mode.

The communication manager 1308 may disable, for communication with the WCD and based at least in part on the WCD being in the mute mode, one or more of a microphone, an encoder, or uplink audio data processing.

The reception component 1302 may receive, from the WCD and after transmitting the one or more empty packets, an indication that the WCD is no longer in the mute mode.

The transmission component 1304 may transmit, to the WCD, one or more packets with audio data.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by an audio device, comprising: receiving, from a wireless communication device (WCD), an indication that the WCD is in a mute mode; and transmitting, to the WCD, one or more empty packets based at least in part on the WCD being in the mute mode.

Aspect 2: The method of Aspect 1, wherein receiving the indication that the WCD is in the mute mode comprises receiving the indication via a first link, and wherein transmitting the one or more empty packets comprises transmitting the one or more empty packets via a second link that is different from the first link.

Aspect 3: The method of Aspect 2, wherein the first link comprises a low energy link, and wherein the second link comprises an audio link.

Aspect 4: The method of any of Aspects 1-3, further comprising disabling, for communication with the WCD and based at least in part on the WCD being in the mute mode, one or more of: a microphone, an encoder, or uplink audio data processing.

Aspect 5: The method of any of Aspects 1-4, wherein the one or more empty packets comprise one or more packets without audio data from a microphone of the audio device.

Aspect 6: The method of any of Aspects 1-5, wherein transmitting the one or more empty packets comprises: transmitting the one or more empty packets with a reduced air time relative to a packet having audio data.

Aspect 7: The method of any of Aspects 1-6, further comprising: receiving, from the WCD and after transmitting the one or more empty packets, an indication that the WCD is no longer in the mute mode; and transmitting, to the WCD, one or more packets with audio data.

Aspect 8: The method of any of Aspects 1-7, wherein the mute mode is associated with an audio stream from the WCD to an additional device.

Aspect 9: A method of wireless communication performed by a wireless communication device (WCD), comprising: transmitting, to an audio device, an indication that the WCD is in a mute mode; and receiving, from the audio device, one or more empty packets based at least in part on being in the mute mode.

Aspect 10: The method of Aspect 9, wherein transmitting the indication that the WCD is in the mute mode comprises receiving the indication via a first link, wherein receiving the one or more empty packets comprises transmitting the one or more empty packets via a second link that is different from the first link.

Aspect 11: The method of Aspect 10, wherein the first link comprises a low energy link, and wherein the second link comprises an audio link.

Aspect 12: The method of any of Aspects 9-11, further comprising disabling, for communication with the WCD and based at least in part on the WCD being in the mute mode, one or more of: a microphone, an encoder, or uplink audio data processing.

Aspect 13: The method of any of Aspects 9-12, wherein the one or more empty packets comprise one or more packets without audio data from a microphone of the audio device.

Aspect 14: The method of any of Aspects 9-13, wherein transmitting the one or more empty packets comprises: transmitting the one or more empty packets with a reduced air time relative to a packet having audio data.

Aspect 15: The method of any of Aspects 9-14, further comprising: receiving, from the WCD and after transmitting the one or more empty packets, an indication that the WCD is no longer in the mute mode; and transmitting, to the WCD, one or more packets with audio data.

Aspect 16: The method of any of Aspects 9-15, wherein the mute mode is associated with an audio stream from the WCD to an additional device.

Aspect 17: An apparatus for wireless communication at a device, comprising a processor; memory coupled with the processor; and instructions stored in the memory and executable by the processor to cause the apparatus to perform the method of one or more of Aspects 1-16.

Aspect 18: A device for wireless communication, comprising a memory and one or more processors coupled to the memory, the one or more processors configured to perform the method of one or more of Aspects 1-16.

Aspect 19: An apparatus for wireless communication, comprising at least one means for performing the method of one or more of Aspects 1-16.

Aspect 20: A non-transitory computer-readable medium storing code for wireless communication, the code comprising instructions executable by a processor to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An audio device for wireless communication, comprising:
a memory; and
one or more processors, coupled to the memory, configured to:
receive, from a wireless communication device (WCD), an indication that the WCD is in a mute mode; and
transmit, to the WCD, one or more empty packets based at least in part on the WCD being in the mute mode.

2. The audio device of claim 1, wherein the one or more processors, to receive the indication that the WCD is in the mute mode, are configured to receive the indication via a first link, and
wherein the one or more processors, to transmit the one or more empty packets, are configured to transmit the one or more empty packets via a second link that is different from the first link.

3. The audio device of claim 2, wherein the first link comprises a low energy link, and
wherein the second link comprises an audio link.

4. The audio device of claim 1, wherein the one or more processors are further configured to disable, for communication with the WCD and based at least in part on the WCD being in the mute mode, one or more of:
a microphone,
an encoder, or
uplink audio data processing.

5. The audio device of claim 1, wherein the one or more empty packets comprise one or more packets without audio data from a microphone of the audio device.

6. The audio device of claim 1, wherein the one or more processors, to transmit the one or more empty packets, are configured to:
transmit the one or more empty packets with a reduced air time relative to a packet having audio data.

7. The audio device of claim 1, wherein the one or more processors are further configured to:
receive, from the WCD and after transmitting the one or more empty packets, an indication that the WCD is no longer in the mute mode; and
transmit, to the WCD, one or more packets with audio data.

8. The audio device of claim 1, wherein the mute mode is associated with an audio stream from the WCD to an additional device.

9. A wireless communication device (WCD) for wireless communication, comprising:
a memory; and
one or more processors, coupled to the memory, configured to:
transmit, to an audio device, an indication that the WCD is in a mute mode; and
receive, from the audio device, one or more empty packets based at least in part on being in the mute mode.

10. The WCD of claim 9, wherein the one or more processors, to transmit the indication that the WCD is in the mute mode, are configured to receive the indication via a first link,
wherein the one or more processors, to receive the one or more empty packets, are configured to transmit the one or more empty packets via a second link that is different from the first link.

11. The WCD of claim 10, wherein the first link comprises a low energy link, and
wherein the second link comprises an audio link.

12. The WCD of claim 9, wherein the one or more processors are further configured to disable, for communication with the WCD and based at least in part on the WCD being in the mute mode, one or more of:
a microphone,
an encoder, or
uplink audio data processing.

13. The WCD of claim 9, wherein the one or more empty packets comprise one or more packets without audio data from a microphone of the audio device.

14. The WCD of claim 9, wherein the one or more processors, to transmit the one or more empty packets, are configured to:
transmit the one or more empty packets with a reduced air time relative to a packet having audio data.

15. The WCD of claim 9, wherein the one or more processors are further configured to:
receive, from the WCD and after transmitting the one or more empty packets, an indication that the WCD is no longer in the mute mode; and
transmit, to the WCD, one or more packets with audio data.

16. The WCD of claim 9, wherein the mute mode is associated with an audio stream from the WCD to an additional device.

17. A method of wireless communication performed by an audio device, comprising:
receiving, from a wireless communication device (WCD), an indication that the WCD is in a mute mode; and
transmitting, to the WCD, one or more empty packets based at least in part on the WCD being in the mute mode.

18. The method of claim 17, wherein receiving the indication that the WCD is in the mute mode comprises receiving the indication via a first link, and
wherein transmitting the one or more empty packets comprises transmitting the one or more empty packets via a second link that is different from the first link.

19. The method of claim 18, wherein the first link comprises a low energy link, and
wherein the second link comprises an audio link.

20-23. (canceled)

24. A method of wireless communication performed by a wireless communication device (WCD), comprising:
transmitting, to an audio device, an indication that the WCD is in a mute mode; and
receiving, from the audio device, one or more empty packets based at least in part on being in the mute mode.

25-30. (canceled)
